(19) United States
(12) Patent Application Publication
(10) Pub. No.: US 2024/0212049 A1
(43) Pub. Date: Jun. 27, 2024

(54) SYSTEMS AND METHODS FOR OPTIMIZATION AND VISUALIZATION USING EFFICIENT FRONTIERS

(71) Applicant: THE TORONTO-DOMINION BANK, TORONTO (CA)

(72) Inventors: MAHDI GHELICHI, TORONTO (CA); MICHAEL CRISTEA, TORONTO (CA)

(21) Appl. No.: 18/456,296

(22) Filed: Aug. 25, 2023

Related U.S. Application Data
(60) Provisional application No. 63/435,035, filed on Dec. 23, 2022.

(51) Int. Cl. G06Q 40/06; G06F 3/0481; G06F 3/04842; G06T 11/20

(52) U.S. Cl. CPC G06Q 40/06; G06F 3/0481; G06F 3/04842; G06T 11/206; G06T 2200/24

(57) ABSTRACT

A computing device configured to generate a computerized portfolio optimization and management tool is provided which communicates with a display for providing a graphical user interface (GUI) of the tool and receives input interacting with the GUI for updating the tool. The computing device produces a UI with which to visualize multiple portfolios on a graph in terms of efficiency metrics with respect to a visualization of efficient frontiers and/or constraint efficient frontiers and to allow user inputs on the UI, for example on asset allocation tables and/or on the graph displayed to allow reducing a gap between the efficient frontier and the visualized portfolio. For example, the UI also provides controls for defining constraints for the portfolio features such as asset allocations to generate a modified constraint-based efficient portfolio. In examples, the tool may further reset UI inputs received to feasible values based on criteria predetermined.

### CROSS-REFERENCE TO RELATED APPLICATIONS

This application claims priority from U.S. Provisional Patent Application No. 63/435,035, filed Dec. 23, 2022, and entitled “SYSTEMS AND METHODS FOR PORTFOLIO OPTIMIZATION AND VISUALIZATION BY EFFICIENT FRONTIERS”, the entire contents of which are hereby incorporated by reference herein.

### FIELD

The present disclosure relates to systems and methods for generating computerized tools for portfolio optimization and visualization using efficient frontiers.

### BACKGROUND

Entities constantly make decisions regarding various trade-off analysis of transaction data, portfolios of transactions, and determine actions, recommendations or next transactional steps involving a risk/return analysis. Typically, the amount of data and the disparate digital sources of such digital data across a computing network environment with large number of computing devices transacting makes analysis and manual visualization a very difficult task. In instances where an entity wants to locate visually optimal points of interest for a portfolio of transactions, then the entity may have difficulty manually visualizing, locating and identifying such optimal points in large transactional data.

For example, entities may be tasked to optimize allocations relating to credit facilities, business proposals, and/or investments or other types of allocations such as to optimize a target objective. Allocation decisions are complex, and quantitative modelling lacks ability to provide a user interface that aids in assessing the correlation between risk and reward for proposed allocations. It is difficult to effectively manually review the significant volumes of quantitative information required to make complex portfolio optimization decisions and/or to incorporate risk assessments within such optimization.

Existing graphical user interfaces which display stale and outdated information are unable to deal with continually dynamic and changing nature of transactional data which may be communicated across a large network of computing systems.

There is a need for an improved user interface and computerized tool, method and system which addresses at least some of the shortcomings of the existing data management technologies.

### SUMMARY

In at least some aspects, it is desirable to provide computerized tools for managing portfolios such as digitally and dynamically visualizing various iterations and possible additions to asset portfolios, such as but not limited to, portfolios for example of asset capital allocations (e.g. assets, risk, returns, various features) and to visualize how to best manage such portfolios based on defined efficiency metrics, e.g. reward objectives/risk tolerances.

Thus, in at least some aspects, there is a need for computerized systems, methods and tools to present and interactively visualize asset allocation data simply and efficiently, such as to allow for interactive manipulation, scenario generation, visual comparison between various asset allocation scenarios and weights, and optimization using efficient frontier curves.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a system and may include a computer having at least one processor and a non-transient storage medium storing computer readable instructions.

In at least one aspect, there is provided a system comprising a computer having at least one processor and a non-transient storage medium storing computer readable instructions, that when executed by said at least one processor of the computer, cause the computer to perform operations comprising: providing a user interface screen for portfolio optimization, the user interface screen comprising: a first curve displayed on a graph of expected returns and risk, the first curve indicating an efficient frontier of a model portfolio, the first curve derived from historical asset allocation data comprising features describing a set of historical assets, the historical asset allocation data provided as a first input from a transaction input device; a data point overlaid on the graph indicating positioning of an initial portfolio relative to the efficient frontier, the initial portfolio retrieved based on a second input of asset allocation data describing a set of assets defined using the same features as the first input, the assets defined in an interactive asset allocation table for including proposed allocations for each of the assets and displaying efficiency metrics for each of the assets predicted, by a prediction engine, from the historical asset allocation data; a second curve displayed on the graph indicating a modified efficient frontier of feasible adjustments based on a third input of predetermined limits of upper and lower bounds of the features for at least one asset in the asset allocation table; responsive to receiving an instruction from an input device to modify at least one asset of the set of assets on the user interface screen indicative of generating a test portfolio: generate modifications to the asset allocation table displayed and predict, by the prediction engine, updated efficiency metrics for each of the assets in the test portfolio based on the historical asset allocation data; and update the user interface screen to generate a display of a test data point based on the updated efficiency metrics for the test portfolio overlaid on the graph with the initial portfolio thereby visualizing a comparison of the test portfolio relative to the initial portfolio, the efficient frontier and the modified efficient frontier on a single graph.

In yet another aspect, the instructions further cause operations comprising: determining, via communications of the instruction with a constraints engine whether the modifications satisfy predefined set of constraints defining permissive modifications to the set of assets; responsive to determining that at least one modification does not satisfy the predefined set of constraints, automatically adjusting the modification in the instruction to satisfy the permissive modifications; and, generate a notification on the user interface screen indicating adjusting the modification.

In yet another aspect, the instruction to modify at least one asset further comprises one of: modifying asset class weight of one asset relative to other assets held in a particular portfolio; and adding a new asset with associated asset class weight, the instruction causing the computer to predict, using the prediction engine, a new efficiency metric for the test portfolio including expected return and risk based on the historical asset allocation data.

In yet another aspect, each asset in the asset allocation table is associated with an expected risk and an expected return defining a particular efficiency metric for an asset.

In yet another aspect, receiving the instruction to modify at least one asset is received via an instruction to modify the asset on the asset allocation table or by selecting one or more data points on the graph of expected returns versus expected risk.

In yet another aspect, at least some of the data points in the first curve and the second curve providing the efficient frontier and the modified efficient frontier displayed on the graph are selectable such that the selection causes the initial portfolio to modify the proposed allocations to said selection and update the efficiency metric.

In yet another aspect, the user interface screen provided is configured to display a plurality of hypothetical asset allocation scenarios in both the asset allocation table and the graph to visualize a comparison to the efficient frontier and the modified efficient frontier.

In yet another aspect, the system further comprises a machine learning model on the computer (e.g. prediction engine), having been trained on the historical asset allocation data, and further configured to predict a target asset allocation weighting to modify the proposed allocation for each said asset in the asset allocation table and display the target asset allocation weighting to improve a fit between a data point representing the initial portfolio on the graph and a predetermined one of the first curve and the second curve displayed on the user interface screen.

In yet another aspect, the instructions when executed by said at least one processor further cause operations of the computer comprising: causing the user interface screen to display the asset allocation table configured to be editable to receive the third input from the input device, the asset allocation table displaying a table of features for each asset, the features comprising the upper bound and the lower bound of permissible increase or decrease in each asset with respect to other asset allocations.

In yet another aspect, the instructions, when executed by the processor, further cause the computer to generate the user interface screen to visually differentiate on the first curve and the second curve, between various levels of expected risk and return such as to indicate one or more optimal points of each portfolio.

In yet another aspect, in response to receiving an input from the input device for selecting points on the graph of the efficient frontier or the modified efficient frontier, the instructions, when executed by the processor, further cause the computer to update the asset allocation table and associated proposed allocations to reflect the selected points and associated values reflective of optimal expected return and risk.

In yet another aspect, there is provided a computer implemented method comprising: providing, by a computer, a user interface screen for portfolio optimization, the user interface screen comprising: a first curve displayed on a graph of expected returns and risk, the first curve indicating an efficient frontier of a model portfolio, the first curve derived from historical asset allocation data comprising features describing a set of historical assets, the historical asset allocation data provided as a first input from a transaction input device; a data point overlaid on the graph indicating positioning of an initial portfolio relative to the efficient frontier, the initial portfolio retrieved based on a second input of asset allocation data describing a set of assets defined using the same features as the first input, the assets defined in an interactive asset allocation table for including proposed allocations for each of the assets and efficiency metrics for each of the assets predicted, by a prediction engine, from the historical asset allocation data; a second curve displayed on the graph indicating a modified efficient frontier of feasible adjustments based on a third input of predetermined limits of upper and lower bounds of the features for at least one asset in the asset allocation table; responsive to receiving an instruction, by the computer and from an input device, to modify at least one asset of the set of assets on the user interface screen indicative of generating a test portfolio: generate, by the computer, modifications to the asset allocation table displayed and predict, by the prediction engine, updated efficiency metrics for each of the assets in the test portfolio based on the historical asset allocation data; and update, by the computer, the user interface screen to generate a display of a test data point based on the updated efficiency metrics for the test portfolio overlaid on the graph with the initial portfolio thereby visualizing a comparison of the test portfolio relative to the initial portfolio, the efficient frontier and the modified efficient frontier on a single graph.

In one aspect there is provided, a computer implemented method comprising: accessing, by a computing device, and from a first transaction device, a first input of historical asset allocation data comprising features describing each of the assets and historical efficiency metrics; receiving, by the computing device, and from an input device, a second input of proposed asset allocation data defined using the features as the first input; receiving, by the computing device, and from the input device, a third input of predetermined restrictions on asset allocations provided on the user interface, the restrictions comprising upper and lower bound ranges for at least one asset; applying the first, second and third input, by the computing device, to a machine learning model to: generate and present a constraint efficient frontier curve on the display using the restrictions and the historical allocation data having the historical efficiency metrics; predict, based on the constraint efficient frontier curve, a set of hypothetical modification changes to allocation weighting from the proposed asset allocation data based on relative risk reward ratio retrieved from the constraint efficient frontier curve and within the predetermined restrictions to lessen the difference between the proposed asset allocation data and the constraint efficient frontier curve; and, present the predicted modification changes and the constraint efficient frontier curve on a screen of the user interface for interaction therewith.

Other embodiments of this aspect include corresponding computer systems, apparatus, and computer programs recorded on one or more computer storage devices, each configured to perform the actions of the methods.

### BRIEF DESCRIPTION OF THE DRAWINGS

These and other features will become more apparent from the following description in which reference is made to the appended drawings wherein:

FIG. 1 is a schematic diagram of a communication system and computing environment to implement portfolio management and optimization tools and output for display a graphical user interface, in accordance with one or more aspects of the present disclosure;

FIG. 2 is a block diagram of a portfolio optimizer device suitable for use in the communication system and environment, in accordance with one or more aspects of the present disclosure;

FIGS. 3-9 are diagrams illustrating various example digital user interface screens or portions thereof or screen shots, as generated by the portfolio optimizer device and the portfolio optimization tool, in accordance with one or more aspects of the present disclosure;

FIG. 10 is a flowchart illustrating one example of a method of operation executed by the portfolio optimizer for portfolio management and visualization.

### DETAILED DESCRIPTION

In at least some aspects, there is provided a computerized portfolio optimization tool for generating customized interactive user interface components and screens (e.g. charts, graphs) for receiving user input and generating various visual portfolio management scenarios and to address at least some of the above-mentioned shortcomings. In addition, in at least some aspects, it is desirable that such computer systems, tools and methods allow for feasibility limitations to be implemented, e.g. but not limited to, limitations on asset allocations to be set, to ensure restrictions on asset allocations are accounted for when making asset allocation decisions.

The complexity of allocation profiles or portfolios are difficult to process and visualize based on the raw data alone.

In at least some aspects, an improved computerized tool and user interface is required to account for allocation restrictions and/or limits that are feasible for a particular entity.

In addition, there are further feasibility restrictions for allocations of a portfolio, limiting the effectiveness of automated approaches to quantitative allocation decisions. Thus, in at least some aspects, there is a need for a computerized portfolio optimization tool which can implement the feasibility restrictions and/or allow manipulations and/or visualization of same for visualizing and analyzing an optimized portfolio scenario in a graphical user interface having one or more screens for displaying the optimized portfolio scenario.

In at least one aspect, it is an object of the disclosure to provide a computer implemented prediction model (e.g. based on machine learning techniques), which allows for the visualization of an efficient frontier and in some aspects, visualization of reward/risk predictions for new or modified asset allocations. In at least one aspect, the efficient frontier includes the ideal or optimal balance for a given optimization task, e.g. between risk and reward, whilst accounting for predetermined capital allocation restrictions (e.g. risk tolerances). In addition, the disclosed systems and methods provide, in at least some embodiments, for a digital and interactive user interface in which one or more hypothetical allocation decisions can be input, to output an interactive and easily decipherable visual graphical display of how one or more hypothetical allocation decision would alter the efficient frontier of a capital allocation portfolio, e.g. such as to visualize the effect of allocation decisions on the portfolio and predict risk/reward as compared to an optimized portfolio shown in the efficient frontier.

In at least some aspects, there is provided a computerized tool for automatically capturing asset data, such as but not limited to capital allocation data, risk profiles and expected return profile values, and visualizing portfolio composition data points in the form of one or more interactive, selectable and dynamically generated graphical user interface components, including but not limited to modifiable charts and graphs on a visual display of a graphical user interface provided by the computerized portfolio management tool of a computer device.

There is provided, in at least some aspects, a computerized system and method that provides the ability to view, on an interactive graphical user interface, the connection between risk and return relating to future and current capital allocation decisions. At least in some aspects, such systems use a machine learning engine, having been trained with historical allocation, e.g. investment data, and any current capital allocation data, which predicts and illustrates on a user interface of the computer system the expected risk and return associated with particular capital allocation decisions.

In at least some embodiments of the disclosed computer system and method, the machine learning engine determines and outputs an optimal asset allocation portfolio based on predetermined allocation restrictions and having been trained on historical asset allocations, risks and rewards (e.g. using regression techniques).

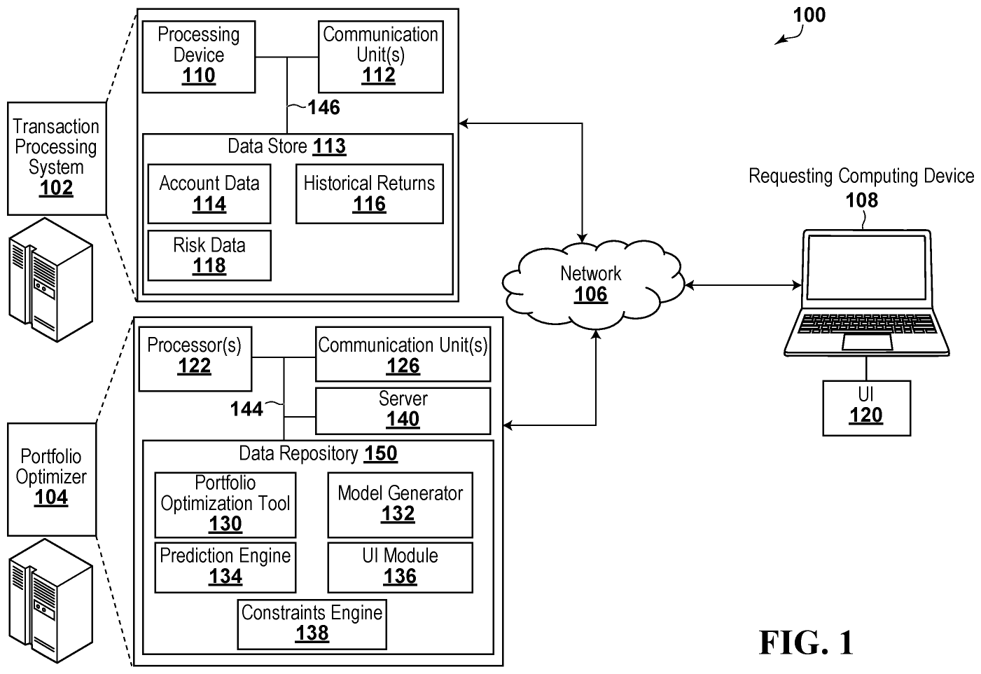

FIG. 1 illustrates an exemplary computing environment 100 consistent with at least one example embodiment of the present disclosure for implementing digital portfolio management, visualization and optimization systems and computerized tool generation. In one aspect, the computing environment 100 comprises a plurality of computing devices, such as one or more requesting computing device(s) 108 which communicate with a transaction processing system 102, and a portfolio optimizer 104 across a communication network which may comprise a wide area network (WAN) such as the Internet. Communication network 106 is coupled for communication with a plurality of computing devices and components as illustrated in FIG. 1. It is understood that the transaction processing system 102, the portfolio optimizer 104, and the requesting computing device as well as the communication network 106 are simplified for illustrative purposes and may include additional computing modules and components to implement the operations and processes as described herein.

In one aspect, each of the portfolio optimizer 104 and the transaction processing system 102 may be one or more computer systems configured to process and store information, and execute software instructions to perform one or more processes and operations consistent with the disclosed embodiments.

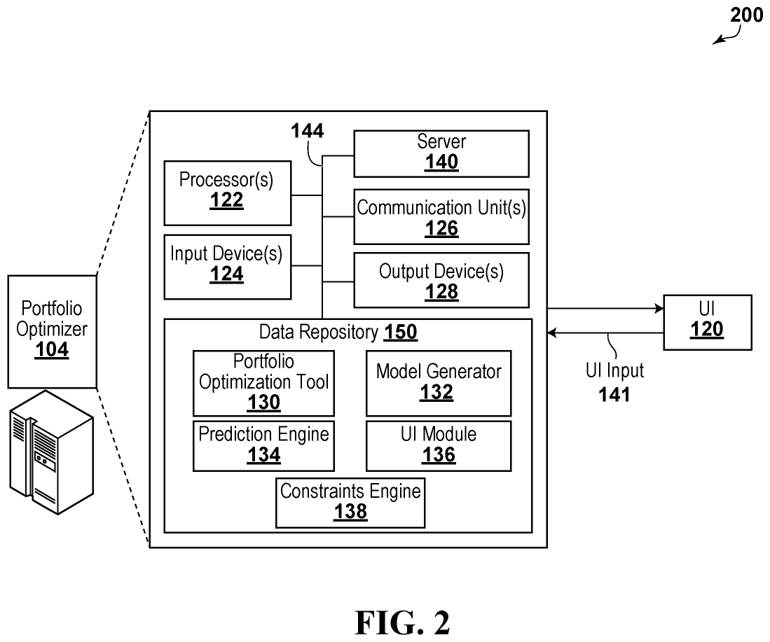

In certain embodiments, and as illustrated in FIGS. 1-2, the portfolio optimizer 104 may include one or more servers 140, at least one processor 122, one or more communication units 126, a communication channel 144 and one or more data storages, such as data repository 150. The data repository 150 may store one or more computing modules, including but not limited to: a portfolio optimization tool 130, a model generator 132, a prediction engine 134, a UI module 136, and a constraints engine 138. The server 140 may be for example, a computer program or a computing system, a computing component which provides a service to another computer, as well as to share resources and distribute work processes. It may process one or more transactions of one or more users and associated computing devices of the environment 100. It may, in at least some aspects, also serve a user interface (UI) or UI components of the user interface or portions of the user interface, such as UI 120 which is generated by the portfolio optimizer 104 and particularly via the portfolio optimizer tool 130 which is configured for portfolio management, visualization and optimization of a portfolio of a set of assets relating to transactions as described herein.

The portfolio optimizer 104 may be implemented with one or more processors or computer based systems such as for example, the computer system 200 of FIG. 2.

In at least some aspects of FIGS. 1-2, the server 140 may act as a web server or a user interface (UI) server that hosts the user interface applications such as digital user interface (UI) 120 and may distribute web pages and web applications to the requesting computing device 108, for portfolio optimization and management. Put another way, in at least some aspects, the portfolio optimizer 104 may communicate in the environment 100 with the requesting computing device 108 and the transaction processing system 102 to generate computerized portfolio optimization tools 130 utilizing prediction engine 134, model generator 132, UI module 136, and a constraints engine 138. In at least some aspects, such portfolio management and optimization computerized tools (e.g. portfolio optimization tool 130) may be made available to the requesting computing device 108 (e.g. or otherwise served via a web server, such as server 140) as the generated user interface (UI) 120 for receiving user input and processing same via UI input 141 (see FIG. 2).

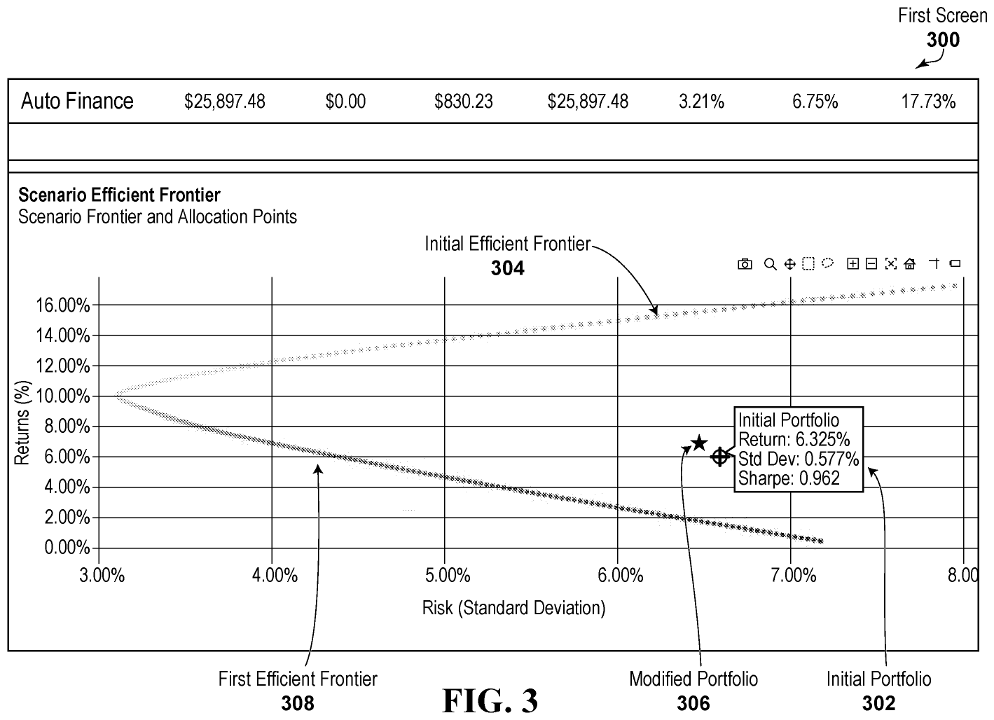

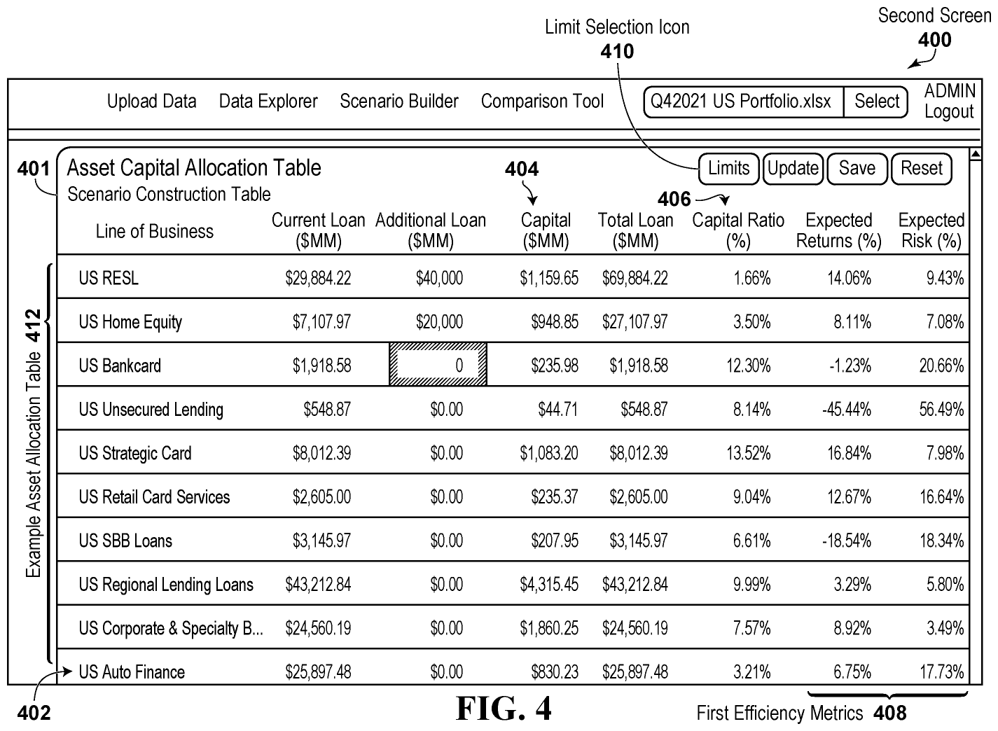

Examples of such UI 120 screens for the digital portfolio optimization tool generated by the portfolio optimizer 104 are shown in FIGS. 3-9. As illustrated a portfolio, may include a combination of digital assets held, including associated features for each asset class and weighting of each asset class with respect to other asset classes held in the portfolio. In some aspects, the assets held in a particular portfolio may include financial assets relating to financial transactions, such as real estate, insurance, automotive, etc. or may include other digital assets such as cryptocurrencies, non-fungible tokens (NFTs), and virtual real-estate in the metaverse, or may include assets relating to other forms of assets or transactions, such as relating to e-commerce, products, goods, utility transactions, energy portfolios, power generation portfolios, water utilities, etc. Generally, the efficient frontier represent a set of portfolios that offer the highest expected return for a given level of risk or the lowest risk for a given level of expected return. In some non-limiting examples, the computerized portfolio optimization tools, e.g. portfolio optimization tool 130 which utilizes efficient frontiers as described herein, may be applied, in some aspects to assist in managing and optimizing portfolios related to electronic task management, supply chain portfolios, energy portfolios for renewable energy projects or holdings. Each portfolio may include for each asset, a class weight or an asset class weight which refers to the proportion or percentage of a portfolio's total value that is allocated to each specific asset class, and may also include other characteristics defining each asset class, an example of which shown in the asset allocation table of FIG. 4 (e.g. see example asset allocation table 412). An asset class may be a group of transactions that share similar characteristics and behave similarly (e.g. assets relating to payment instruments, assets relating to automotive, assets relating to home, etc.). Asset class weights play a role in determining the optimization metrics, e.g. risk and return characteristics of a portfolio. Rebalancing a portfolio or modifying a portfolio may involve adjusting the asset class weights to bring them back in line with desired allocation such as to utilize the computerized tools described herein for ensuring that the portfolio achieves the desired risk-return profile.

Referring again to FIG. 1, the portfolio optimizer 104 is configured, in one aspect, to receive and analyze historical transactions as provided by the transaction processing system 102, via one or more processing devices 110, and communication units 112, such transactions including historical account data 114, historical returns 116 and historical risk data 118 as may be stored within data store 113. As illustrated in the simplified diagram of FIG. 1, the computing components of the transaction processing system may communicate and transfer data across a communication bus 146 or channel. The portfolio optimizer 104 may then be configured to serve a computerized portfolio optimization tool 130 for use in managing portfolios of assets, optimization and visualizing same.

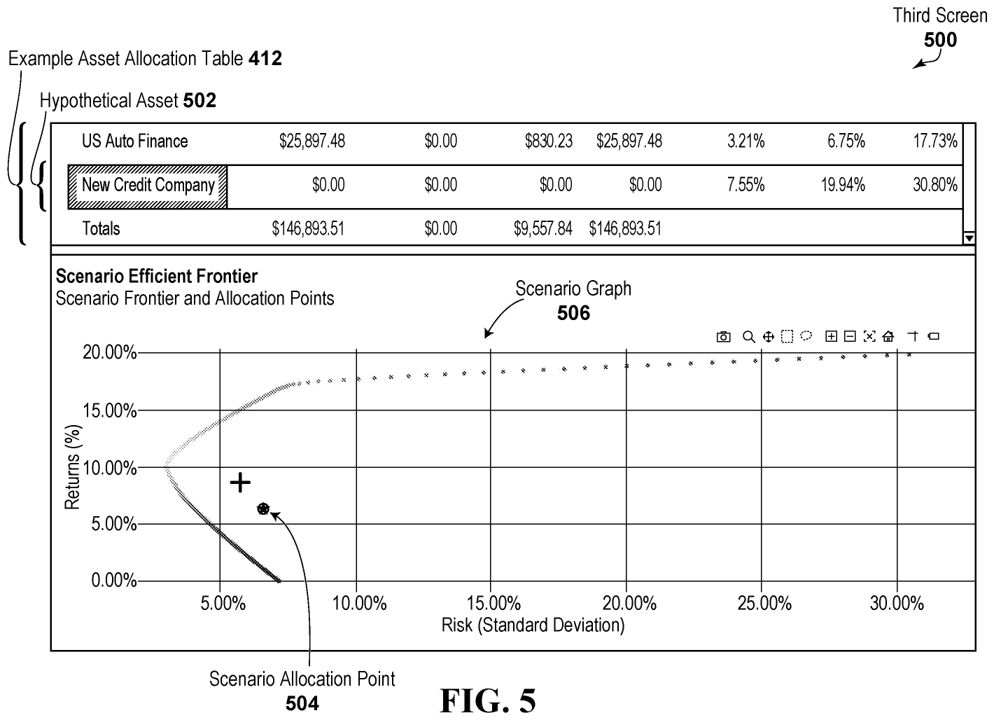

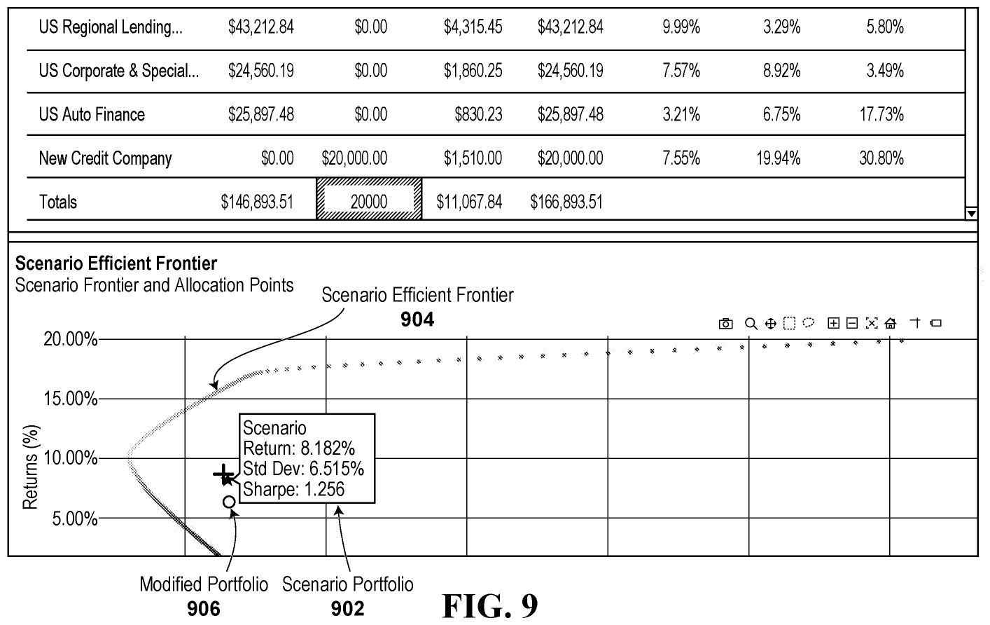

Referring to FIG. 1, the transaction processing system 102 comprises a processing device 110, a communications unit 112, and a data store 113 storing historical account data 114 and associated historical returns 116 and risk data 118. Thus, the transaction processing system 102 may, in at least some aspects, store data records of each historical portfolio, including particular asset classes and asset class weights along with efficiency metrics based on prior performance including prior returns and risks. Such historical account information including information in the data store 113 may be accessed or otherwise provided as input to the portfolio optimizer 104 via the communication network 106, such as to be provided to the prediction engine 134 to utilize, via machine learning techniques, to generate efficiency metrics (expected future risk/reward predictions for hypothetical or proposed asset allocations for a test portfolio as may be provided via UI 120), as for example illustrated in the asset allocation tables of FIGS. 5 and 9 for the “new credit card company” having associated predicted expected returns and risks.

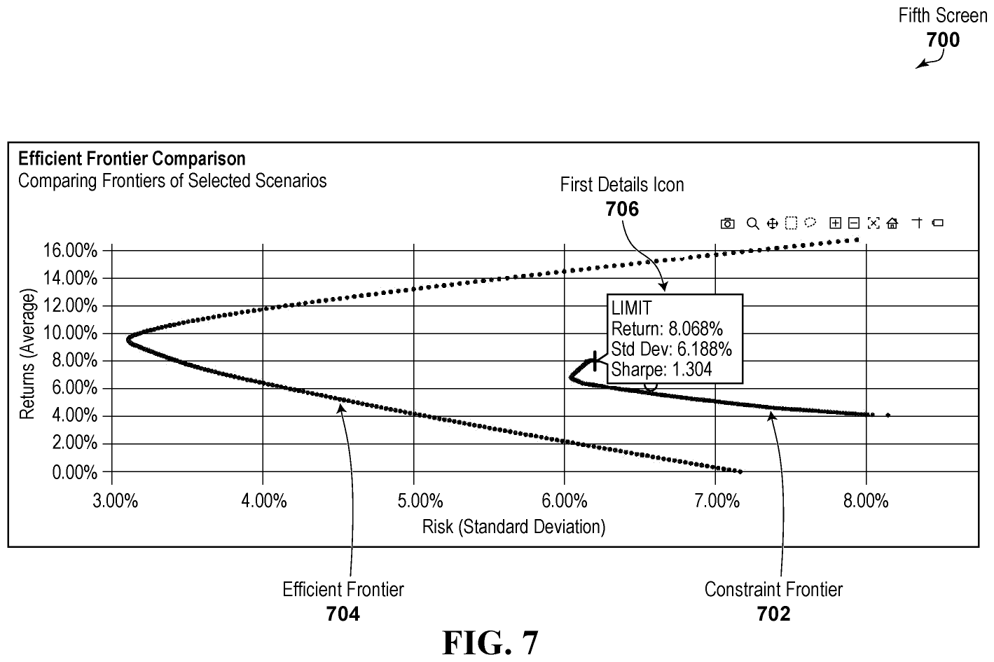

Additionally, such historical account information as provided via the transaction processing system 102 including prior history of transactions, asset classes, associated weighting and historical efficiencies, including historical risk and rewards, are used to generate the efficient frontier curves, or the model portfolio via the illustrated in the UI 120, such as shown in FIG. 3, FIG. 5, and FIGS. 7-9.

To generate the efficient frontier curves, historical data is used, e.g. historical assets and historical returns/risk over time. This historical data, which may be provided from the transaction processing system 102 to the portfolio optimizer 104, includes the historical returns and volatilities (or standard deviations) of different assets that could be included in a portfolio. By analyzing the historical performance of these assets, the model generator 132 can generate an efficient frontier curve (e.g. using modern portfolio theory that represents the set of optimal portfolios that offer the highest expected return for a given level of risk or the lower risk for a given level of expected return) and can apply machine learning methods, via the prediction engine 134 to derive from past performance of historical assets (e.g. historical efficiency metrics of risk and returns) and estimate future expected returns and risks, such as for proposed portfolios or modified assets or modified asset allocations, as shown for example in FIGS. 4-6. The efficient frontier curve may be updated dynamically on the user interface as new data becomes available such as to reflect the most current information. Thus, the efficient frontier curve may also include information for a current portfolio of assets, which may be input into the UI 120 into the asset allocation table displayed on the user interface screen, such as shown in FIG. 4. In some aspects, the scenario construction table 604 may include a field indicative of the percentage of allocation of each particular asset class relative to allocations of other asset classes in the portfolio, e.g. shown as the hypothetical asset allocation 606. In the current example, the hypothetical asset allocation 606 may be a user input or otherwise defined, and shown as manipulating a “capital ratio %” field, although other non-financial asset allocations may be envisioned. In some aspects, the hypothetical asset allocation 604 may define how a particular asset is divided amongst various asset classes of the scenario construction table 604.

In one aspect, the model generator 132 generates the efficient frontier curve (e.g. current or modified with constraints) by varying the allocation weights of different assets, such that a set of portfolios with varying risk-return profiles is generated. These portfolios are then plotted on a graph, via the model generator 132 as provided to the UI module 136 to display on the UI 120 screen to create the efficient frontier curve, such as shown in FIG. 3.

In one aspect, the model generator 132, configured to generate the efficient frontier curve for display on the UI 120 screen may perform the following steps. First the model generator 132 may create a range of portfolios by systematically varying the allocation weights of the assets. This generates a spectrum of portfolios with varying levels of risk and return. Subsequently, the model generator 132 may plot the portfolios on a graph, where the x-axis represents portfolio risk (standard deviation) and the y-axis represents portfolio return. Example implementations of efficient frontiers (or portions thereof) generated by the model generator 132 and displayed on the UI 120 via the UI module 136 for serving a user interface, such as for example on a web page that includes a UI 120 via the web server 140 are for example illustrated in FIGS. 3, 5, 7-9. In one example implementation, the server 140 which may be a web server, may be configured to receive a client's request via a requesting computing device 108. If such a request is for a web page that include a UI module, the server 140 starts preparing the resources to generate the UI content to server in the UI 120. Thus, the server 140 may serve to retrieve resources, such as the portfolio optimization tool 130 generated by the portfolio optimizer 104 to deliver to the requesting computing device 108, such as in the form of websites, or web applications. Each point on the graph of the efficient frontier curve corresponds to a different portfolio. Thus, the model generator 132 may be configured to generate the efficient frontier curve by connecting the points (portfolios) that offer the highest return for a given level of risk. This forms the upper boundary of the graph, which is the efficient frontier.

The shape of the efficient frontier depends on the correlations between the assets in the portfolio. Diversified portfolios with negatively correlated assets tend to have a more convex shape, allowing for better risk-return trade-offs.

Thus, the model generator 132 utilizes historical data analysis of data provided in the transaction processing system 102 to generate and visualize an interactive and selectable efficient frontier curve which is displayed on the UI 120 via the UI module 136 (and in at least some cases delivered via the server 140, acting as a web server to access the portfolio optimization tool with example UI screens displayed in FIGS. 3-9), and provides insights into potential portfolio options. As new data becomes available, such as via inputs received from the requesting computing device 108 of a current portfolio, the efficient frontier curve displayed via the model generator 132 can be updated to reflect the most current information and to adjust portfolio allocations of the efficient frontier and the model portfolio generated by the model generator 132 accordingly. An example efficient frontier for the user interface screen is illustrated in a first screen 300 in FIG. 3.

In at least one aspect of the disclosed computer systems and methods, the portfolio optimizer 104 receives historical transactions and asset allocation data, including risk/reward valuations (e.g. historical returns 116 and risk data 118) from one or more account data systems, such as from transaction processing system 102.

Referring to FIGS. 1-9, in at least some aspects, the portfolio optimizer 104 receives current capital allocation data (e.g. either input via an input device such as the requesting computing device 108 via the UI 120 or accessed via a storage, such as accessed from the transaction processing system 102). For example, the current capital allocation data defining a current portfolio may be input via an asset capital allocation table via a user on the UI 120 such as a screen of the portfolio management computerized tool shown as the second screen 400 in FIG. 4. As shown in the UI screen, the second screen 400 of FIG. 4, the UI 120 displays an editable asset allocation table, shown in a first scenario construction table 401 having a list of asset classes 402, each asset class having a plurality of features 404 defining the asset class including asset class allocations 406 (or weighting of a particular asset class).

As illustrated, each asset class also has an expected return or risk associated therewith. In some aspects, this expected return and/or risk may be retrieved and generated from another prediction engine or the portfolio optimization tool 130 may cause the prediction engine 134 to generate the expected return or risk for each asset class based on the historical allocation data including historical returns and risks, such as that provided by the transaction processing system 102, which may then be used by the prediction engine 134 to apply one or more machine learning forecasting techniques (e.g. Artificial Neural Network (ANN)), Long short-term-memory-based neural network, Random forest) to predict expected return and expected risk (e.g. efficiency metrics) for each scenario. For example, the machine learning algorithms implemented by the prediction engine 134 may include regression algorithms such as but not limited to: linear regression algorithms including random forest or gradient boosting which apply historical asset data retrieved from the transaction processing system 102 shown as first efficiency metrics 408 indicating expected returns and risk for a sample current allocation data set displayed on an allocation table such as shown in the second screen 400, e.g. example asset allocation table 412.

Referring to FIGS. 1-9, the portfolio optimizer 104 of FIG. 1 is further configured, in at least one aspect to provide or serve a graphical user interface, shown as UI 120, such as by way of the portfolio optimization tool 130 generating the portfolio management and visualization application, which may be then configured into a user interface via the UI module 136 and served to the requesting computing device 108 by way of the UI 120. The user interface generated by the portfolio optimizer 104, e.g. UI 120, may further be configured to receive inputs of proposed allocation restrictions, via the requesting computing device 108. Such inputs of proposed allocation restrictions for each asset class may be input via an editable and interactive asset allocation table displayed on the UI 120, as shown in the example asset allocation table 412 of FIG. 4 (e.g. input by a user of the requesting computing device 108). The user interface screen, e.g. second screen 400, may present a selectable GUI icon for selection, shown as limit selection icon 410, which when selected triggers a new screen, such as the fourth screen 600 with the input allocation restrictions 602.

An example of receiving an input command or instruction for inputting allocation restrictions is illustrated in the fourth screen 600 having example input allocation restrictions 602, defining an upper bound and lower bound for deviating from a given feature value or target feature value (e.g. capital value) of each asset class which will then modify the percentage allocation of the asset class relative to others. Once such input restrictions are received by the UI 120, they are relayed to the portfolio optimization tool 130 which based on determining that there are updated constraints triggers the constraints engine 138 to review such constraints. The constraints engine 138, which may be a computing component that is configured to find solutions to optimizing the portfolio with multiple constraints or limitations.

In at least some aspects, such constraints once input into the UI 120, such as via one or more user interface screens are then relayed to the constraints engine 138 to cause the generation of an updated efficient frontier which optimizes the asset allocation problem by further adhering to the added constraint limitations such as that shown in FIG. 7 illustrating a constraint frontier curve 702 displayed on the same UI screen, e.g. the fifth screen 700 as the efficient frontier 704 on a graph displaying returns versus risk (standard deviation).

In at least one example implementation, the portfolio optimizer 104 conveniently manages and visualizes the efficient frontier curve on interactive UI screens, or portions of the screens, via a generated user interface UI 120 and in some aspects, the constraint efficient frontier generated in accordance with processes described herein, along with visualizing one or more particular proposed portfolios of asset, allocations and various efficiency metrics on the UI screen in an image graph as different visual scenario in a manner as to assess the efficiency of each proposed portfolio to determine whether the portfolio has for example, an ideal distribution thereby quantifying and visualizing optimal allocation of assets in an interactive digital user interface to allow for such visualization. The portfolio optimizer 104, in at least some aspects, further automatically determines efficiency metrics, utilizing the portfolio optimization tool 130, for each proposed portfolio scenario based on applying machine learning techniques via the prediction engine 134 described herein and historical asset data such as to determine ideal placement of the portfolio scenario relative to the efficient frontier curves and whether the portfolio asset allocations are ideal (e.g. via visualized placements of a give portfolio on the UI screen) or whether further adjustments are needed in order to achieve optimal allocation of assets.

In one aspect, the portfolio optimizer 104, having a portfolio optimization tool 130 which utilizes a model generator 132 configured to generate and plot an efficient frontier graph indicative of a model portfolio to facilitate in assessing the efficiency of a particular portfolio relative to the efficient frontier. The portfolio optimizer 104 is trained on the historical asset allocation data (and in some examples, current asset portfolio allocations and expected risks/returns) to automatically generate efficient frontier graphs such as that shown in FIG. 3, and output such graphs, via the UI module 136 onto a graphical user interface of a computing device such as UI 120 for subsequent interaction by a user of the requesting computing device 108, including visualization of hypothetical scenarios of allocations, assets, features, limitations, and/or risks or other features on the user interface UI 120 and implementation of same.

In at least one aspect, the UI 120 generated is configured such that the current portfolio input into the UI, either input via the asset allocation table or otherwise uploaded via the requesting computing device 108 is also processed by the portfolio optimizer 104 and particularly by the portfolio optimization tool 130, such as to cause generation of a marker or data point indicative of the values of the current or initial portfolio (e.g. expected return, standard deviation as may be predicted via the prediction engine 134) on a graph displaying concurrently the efficient frontier, such as the first screen 300 shown in FIG. 3. In FIG. 3, the initial portfolio 302 marker is shown on the first screen 300 illustrating also the efficient frontier 304.

The machine learning system may include or be included in a computing device, a server, a cloud computing environment, etc. such as to implement the particular processes and methods described herein.

As shown in FIGS. 3-5 and 7-9, an example graphical user interface, e.g. UI 120, generated from the portfolio data provides an output of one or more graphs displaying the efficient frontier for portfolios applying the model generator 132 and the prediction engine 134. Preferably, the model generator 132 configures the displayed graph on the UI 120 to be colour coded or otherwise visually differentiate between different risk/return valuations and to further visually differentiate the optimal ranges of asset allocations on the graph.

For example, the portfolio optimization tool 130 may receive current portfolio data (e.g. via inputs on an asset allocation table illustrated on the UI 120 as shown in second screen 400 FIG. 4 or otherwise uploaded to the computerized asset optimization tool) and generate a marker or other visual indicator of the initial portfolio on the graph, e.g. first screen 300 along with an initial efficient frontier 304 curve.

The efficient frontier curve, e.g. the initial efficient frontier 304, displayed on the one or more graphs of the graphical user interface such as UI 120 dynamically changes, via the model generator 132, in response to current asset allocation data, historical asset allocation data and predetermined allocation restrictions.

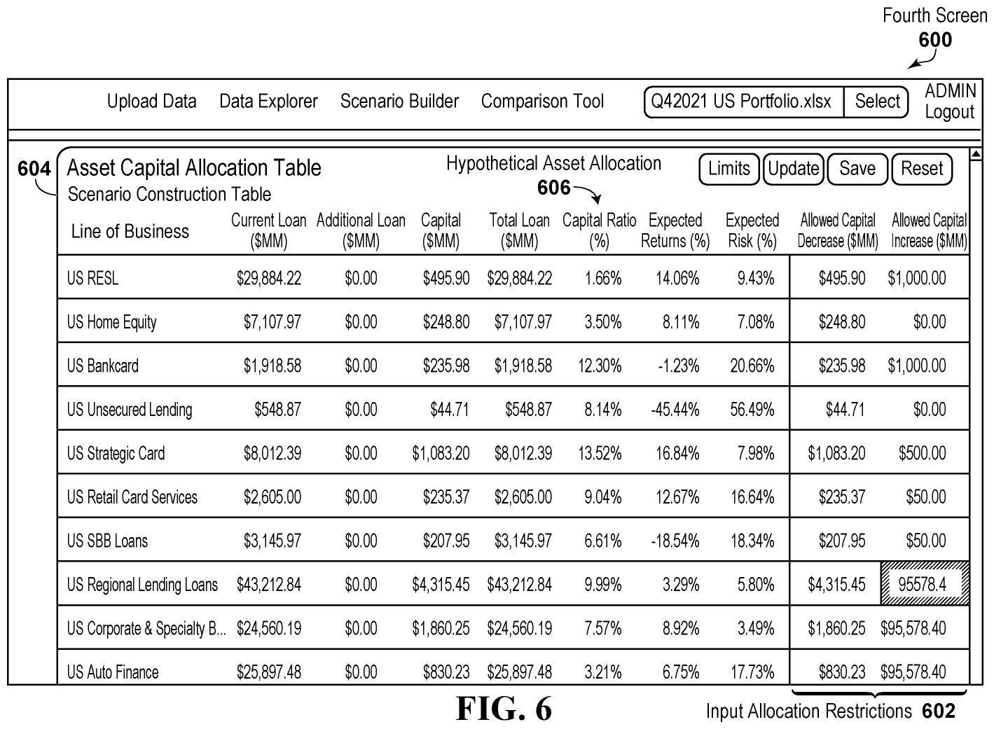

A user may further input on the UI 120 hypothetical asset allocation data, e.g. UI input 141, such as to modify one or more features of the assets or add new assets or delete assets having associated features (e.g. asset valuation or share of asset relative to others such as hypothetical asset allocation 604 in FIG. 6) to cause the portfolio optimizer 104 to generate one or more graphs for which an updated asset allocation point is generated for the scenario on a standard deviation versus returns graph (e.g. updated allocation scenario as represented by the star in FIG. 3 showing the modified portfolio 306, a different indicator showing a circle for the initial portfolio 302), thereby allowing a user of the requesting computing device 108 to visually and easily determine if the hypothetical asset allocation portfolio, e.g. a test portfolio, would bring an allocation change in the portfolio closer or further from the displayed efficient frontier (e.g. first efficient frontier 308 in FIG. 3 or in the case of FIG. 9, displaying a scenario portfolio 902, a modified portfolio 906 shown relative to the scenario efficient frontier 904). Thus, the UI 120 generated allows generation of various scenarios, e.g. as input on the asset allocation table.

In one example, such user input may be provided directly within one or more field values of one or more fields of an example asset allocation table 412 (e.g. as shown in the third screen 500 of FIG. 5, illustrating an example UI screen) whereby entering a new asset, shown as a new hypothetical asset 502 and associated set of features including allocations, cause the UI 120 to generate an updated efficient frontier graph such as to update the location of the scenario allocation point 504 on the scenario graph 506.

Thus, the portfolio optimization tool 130 is configured to update the UI in response to changes to the asset allocations (e.g. via the asset allocation table) and cause updated asset allocation points to appear on the graph with the efficient frontier and/or constraint efficient frontier curves. As illustrated for example in the first screen 300 of FIG. 3, the initial portfolio 302 asset allocation points and the modified portfolio 306 are visually differentiated, and may have a unique visual indicator such as a flag, a marker or other GUI indicator to uniquely identify the asset allocation point with respect to the efficient frontier curves. For example, a colored flag or marker, or an icon (e.g. a star or circle as shown) may be used. The marker may also be accompanied by a text label displayed in the GUI of the portfolio optimization tool 130 application shown in the UI 120.

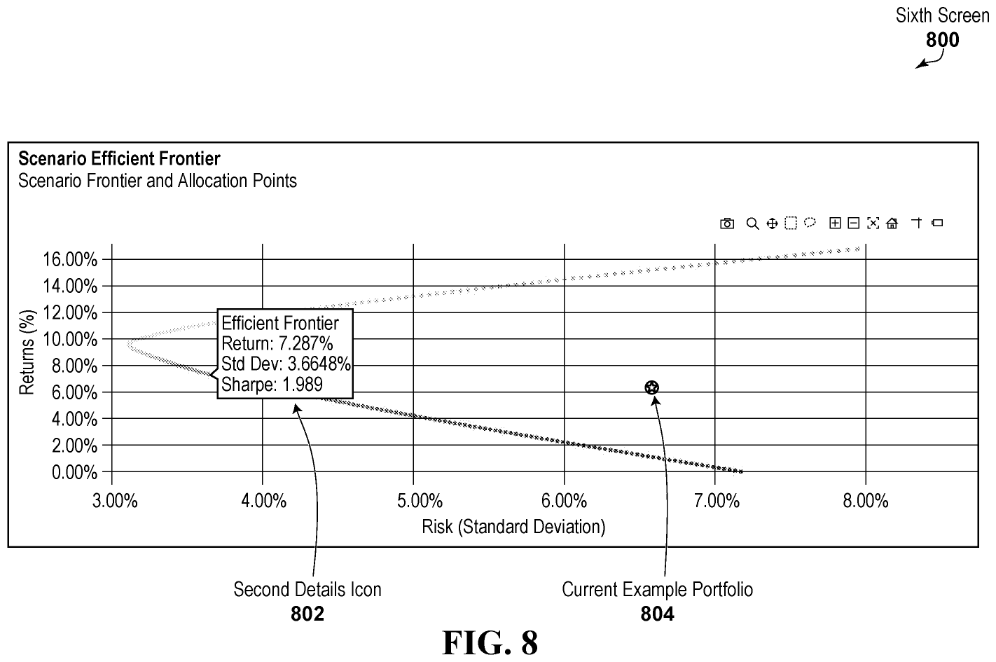

As illustrated in the example screen shot of sixth screen 800 in FIG. 8, at least a portion of the UI 120 provides visual components including interactive graphs, whereby the allocation points on the efficient frontier curve(s) are selectable on the interface to generate a visualization of the details of the efficient frontier data points and features leading to the visualization shown as the second details icon 802. The selection of the points of the efficient frontier may, in some aspects, generate a further detail textual icon, detailing the features of the selected allocation point. In some aspects selection of a particular point on the efficient frontier graph may further provide the option of modifying a current portfolio (e.g. current example portfolio 804) to such a point and propagating the modified portfolio to the asset allocation table including potential assets, and features for visual display. In other aspects, the current example portfolio 804 may be modified such as by dragging the icon for the example portfolio to another point on the graph including on the efficient frontier curve.

In another example screen shot view illustrated in FIG. 7, the fifth screen 700 generates the first details icon view 706 by selecting a point on the constraint frontier curve 702. Such selection may also cause the UI 120, via the portfolio optimizer 104, to update the current asset allocation table to achieve the selected asset allocation selected on the graph.

In at least some aspects, there is generated on the user interface, a scenario construction table user interface, an example of which is shown in FIG. 6 as the scenario construction table 604, on the graphical user interface screen (e.g. fourth screen 600) generated by the portfolio optimizer 104 as the UI 120, which receives hypothetical asset allocation decisions (e.g. a list of asset classes for a given portfolio, features including hypothetical asset allocation 606) and predetermined restrictions shown as input allocation restrictions 602 (e.g. allowable capital decrease; allowable capital increase; or other feature variation bounds for the target feature being optimized) as input on the user interface, e.g. UI input 141 and displays same on the user interface screen.

The example scenario construction table (e.g. shown as scenario construction table 604 in FIG. 6, example asset allocation table in in FIG. 4) is configured to receive asset allocation data from inputs received on a graphical user interface, UI 120, related to asset data, class groupings and their associated features for optimizing the portfolio (e.g. Expected Returns (%); Expected Risk (%); as shown in FIGS. 4 and 6). Such features defining each asset class in an asset allocation table displayed on the user interface may include but not limited to asset classes, asset allocations 604, first efficiency metrics 408, and allocation restrictions 602 defining upper and lower bounds, etc.

According to one or more embodiments of the disclosure, the machine learning model, having been trained on the historical investment data, receives an input of current capital allocation data (e.g. a current investment portfolio) and is configured to predict and display proposed changes (e.g. an increase or decrease in a particular investment) to current capital allocation data, to increase (e.g. improve) the fit between a graphical efficient frontier representing the current capital allocation data and the ideal efficient frontier, accounting for one or more predetermined allocation restrictions.

In at least some aspects, various embodiments of the portfolio optimizer 104 enable an improved user interface experience in the field of digital portfolio management, optimization and visualization.

While financial examples such as capital asset allocations may be described in various examples throughout the present disclosure, it should be understood that the present techniques are not so limited, as the present techniques may be utilized to generate and manage computerized tools for portfolio management and interactive digital visualization in numerous different types of context of portfolios of data records, such as utility, energy, power, computer resource utilization, such as to maximize one target variable (e.g. return) and minimize another variable (e.g. risk), such contexts of application will be apparent to a person of skill in the art.

Reference is next made to FIG. 2 which is a diagram illustrating in block form an example computing device, e.g. a computer system 200 for implementing the portfolio optimizer 104 and for use in the communication system and environment of FIG. 1.

The portfolio optimizer 104 includes at least one processor 122 (such as a microprocessor) which controls the operation of the portfolio optimizer 104. The processor 122 is coupled to a plurality of components and computing components via a communication bus or channel, shown as the communication channel 144,

Portfolio optimizer 104 further comprises one or more input devices 124, one or more communication units 126, one or more output devices 128 and one or more servers 140 or server components. Portfolio optimizer also includes one or more data repositories 150 storing one or more computing modules and components such as a portfolio optimization tool 130, a model generator 132, a prediction engine 134, a UI module 136, and a constraints engine 138.

Communication channels 144 may couple each of the components for inter-component communications, including portfolio optimization tool 130, model generator 132, prediction engine 134, UI module 136, constraints engine 138 whether communicatively, physically and/or operatively. In some examples, communication channels 144 may include a system bus, a network connection, an inter-process communication data structure, or any other method for communicating data.

Referring to FIGS. 1 and 2, one or more processors 122 may implement functionality and/or execute instructions within portfolio optimizer 104. The processor 122 is coupled to a plurality of computing components via the communication bus or communication channel 144 which provides a communication path between the components and the processor 122. For example, processors 122 may be configured to receive instructions and/or data from storage devices, e.g. data repository 150, to execute the functionality of the modules shown in FIG. 2, among others (e.g. operating system, applications, etc.). Portfolio optimizer 104 may store data/information as described herein for the process of generating a portfolio optimization tool 130 which may be delivered to one or more computing devices, such as requesting computing device 108, by way of UI 120. Such data/information may include but not limited to, UI input 141, historical asset data and accounts data, including risk data and returns data from transaction processing system 102, and various UI inputs/outputs as received across the computing environment 100. Some of the functionality is described further herein.

One or more communication units 126 may communicate with external devices via one or more networks (e.g. communication network 106) by transmitting and/or receiving network signals on the one or more networks. The communication units may include various antennae and/or network interface cards, etc. for wireless and/or wired communications.

Input devices 124 and output devices 128 may include any of one or more buttons, switches, pointing devices, cameras, a keyboard, a microphone, one or more sensors (e.g. biometric, etc.) a speaker, a bell, one or more lights, etc. One or more of same may be coupled via a universal serial bus (USB) or other communication channel (e.g. 144).

The one or more data repositories 150 may store instructions and/or data for processing during operation of the portfolio optimizer 104. The one or more storage devices may take different forms and/or configurations, for example, as short-term memory or long-term memory. Data repositories 150 may be configured for short-term storage of information as volatile memory, which does not retain stored contents when power is removed. Volatile memory examples include random access memory (RAM), dynamic random access memory (DRAM), static random access memory (SRAM), etc. Data repositories, in some examples, also include one or more computer-readable storage media, for example, to store larger amounts of information than volatile memory and/or to store such information for long term, retaining information when power is removed. Non-volatile memory examples include magnetic hard discs, optical discs, floppy discs, flash memories, or forms of electrically programmable memory (EPROM) or electrically erasable and programmable (EEPROM) memory.

Portfolio optimization tool 130 may comprise an application (whether native or browser based) and may be configured to obtain input (e.g. UI input 141 or other input from the communication system and computing environment 100) to perform an action. An action herein may be construed broadly as an operation of portfolio optimizer 104, or modules contained therein, such as the model generator 132, prediction engine 134, UI module 136, constraints engine 138 and server 140. For example, the portfolio optimization tool 130, may receive a request for the portfolio optimization and management application which may be served via the server 140 to generate the UI 120 and provide same to a requesting computing device, e.g. the requesting computing device 108. Another example action, may include triggering the generation and display of the efficient frontier curve on the UI 120, via the model generator 132 in response to receiving historical asset allocation data and/or current portfolio data via the requesting computing device 108 and/or the transaction processing system 102. Another example action, may include receiving an indication of a new or modified portfolio on the UI 120 (e.g. via the scenario construction table created on the UI 120 such as shown in FIG. 4 for one or more scenarios) and the portfolio optimization tool 130 triggering the prediction engine 134 to predict expected returns/risk (e.g. the first efficiency metrics 408) and display same, such by applying the UI module 136 to update the UI 120.

Another example action, may include, in response to receiving an input from the requesting computing device 108 or instruction such as by way of receiving UI input 141 indicative of a change in the asset allocation table, e.g. selection of the limit selection icon 410 of FIG. 4 and creation of limit bounds for one or more assets then the portfolio optimization tool 130 controlling operations of the tool causing the constraints engine 138 to cooperate with the prediction engine 134 to cause updating or generation of the graph(s) for efficient frontiers, or constraint efficient frontiers such as via the model generator 132.

Thus, in at least some aspects, the portfolio optimization tool 130 may cooperate with the model generator 132, the prediction engine 134, the constraints engine 138 and/or the server 140 to generate interactive and dynamic UI screens as shown in FIGS. 3-9 and process inputs received from the screens.

Referring again to FIG. 2, it is understood that operations may not fall exactly within the modules 130, 132, 134, 136, and 138 such that one module may assist with the functionality of another.

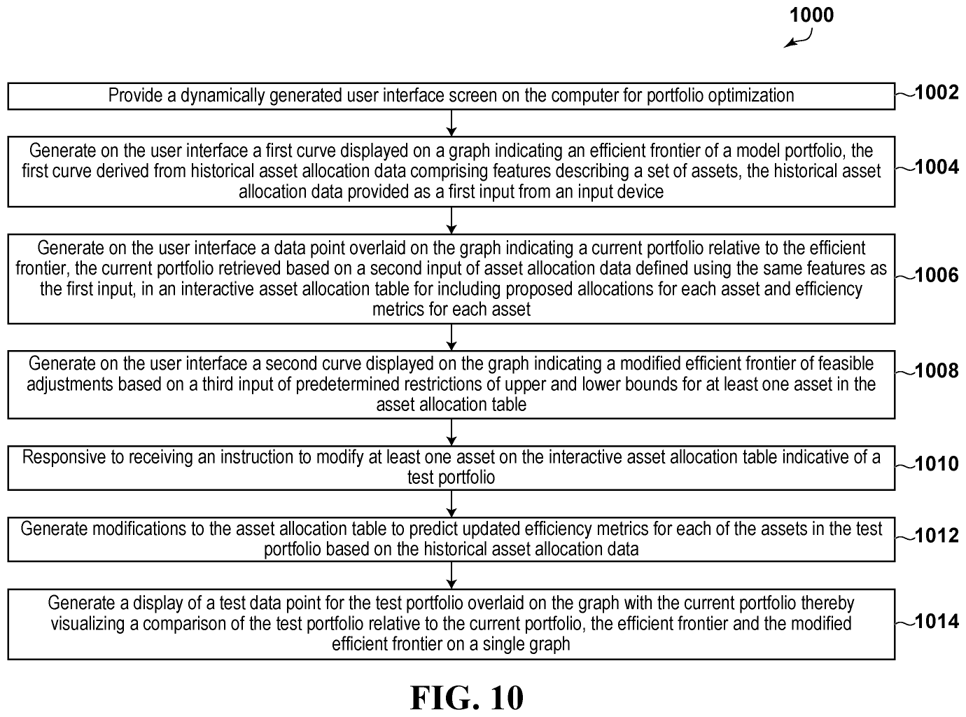

Referring to FIG. 10, there is illustrated an exemplary process for generating a computerized portfolio management tool (e.g. portfolio optimization tool 130 generated by the portfolio optimizer 104) which is delivered to a requesting computing device (e.g. requesting computing device 108) in the form of a digital user interface (e.g. UI 120) for displaying one or more interactive and dynamically generated user interface screens for effectively visualizing multiple portfolios including asset allocations using efficient frontiers and allowing optimization of the portfolios using the visual interface. The generated interactive user interface allows building multiple portfolio scenarios such as by modifying one of more features (e.g. asset allocations) of asset classes or adding/removing asset classes altogether and assessing the outcome of such hypothetical scenarios by allowing inputting of constraints (e.g. via a constraints engine 138 and such scenario construction as discussed with reference to FIGS. 3-9). As discussed assessing such hypothetical scenarios may include visualization of each hypothetical portfolio allocation with respect to an efficient frontier and/or a constraint frontier curve which concurrently displayed on a same graph as the portfolio allocations for various scenarios.

Conveniently, the portfolio optimization tool 130 generates, in at least some aspects, a user-friendly computerized tool and application with an improved user interface (e.g. UI 120) which allows scenario building and assessing various outcomes concurrently and using efficient frontier curves. Further conveniently, the computerized tool allows receiving feasibility constraints and incorporating same into the hypothetical scenario building such as to automatically adjust hypothetical scenarios to ranges which are allowable or considered feasible based on defined constraints.

Referring again to FIG. 10, the flowchart of operations 1000 which may be performed by the portfolio optimizer 104. Initially, the portfolio optimizer 104 may generate and present the portfolio optimization user interface, e.g. UI 120. Thus, at operation 1002, there is provided a user interface screen on the computer (e.g. the requesting computer device 108 across a communication network 106 and in response to a request for portfolio management, visualization and optimization) for portfolio optimization. The user interface screen is configured to display, in operation 1004, a first curve (e.g. an efficient frontier curve as shown in FIG. 3 or 7-8) on a graph of expected returns versus risk (standard deviation). The first curve indicates an efficient frontier of a model or ideal portfolio. As discussed with reference to FIGS. 1 and 2, the efficient frontier curve is derived from historical asset allocation data (which may be uploaded to the user interface, e.g. UI 120 or otherwise input) comprising features describing a set of historical assets. In some aspects, the historical asset allocation data provided as a first input from a transaction input device, such as the transaction processing system 102 over the communication network 106.

At operation 1006, operations of the computing device, e.g. the portfolio optimizer 104 cause an asset allocation data point to be overlaid or located on the graph of the user interface screen indicating positioning of an initial portfolio relative to the efficient frontier. Preferably, the initial portfolio retrieved by the portfolio optimizer 104 based on a second input of asset allocation data describing a set of assets defined using the same features as the first input. These assets may be defined in an interactive asset allocation table (e.g. asset capital allocation table as shown in FIG. 4) for including proposed allocations for each of the assets, including various features defining each asset class and displaying efficiency metrics (e.g. risk/reward) for each of the assets as predicted, by a prediction engine 134, from the historical asset allocation data which is provided by the transaction processing system 102 across the communication network. The records of the asset allocation table may be based on or derived from records of a data provider, such as the transaction processing system 102, which may provide data records related to transactions and asset holdings for one or more current and historical portfolios. When the assets relate to financial transactions, the asset allocation table may have fields which include but are not limited to: line of business, current loan, additional loan (e.g. expected scenario of potential additional loan), capital, total loan, capital ratio, expected returns and expected risks. Thus, in at least some aspects, the user may select one or more tags for one or more records to cause editing of a particular data record for an asset and associated field.

At operation 1008, operations of the computing device, e.g. the portfolio optimizer 104 cause a second curve to be concurrently displayed on the graph of returns versus risk (standard deviation), such as via the model generator 132, indicating a modified efficient frontier of feasible adjustments for one or more of the asset class features based on a third input of predetermined limits of upper and lower bounds of the features for at least one asset in the asset allocation table (e.g. see FIG. 4 showing a second screen with a limit selection icon 410 for triggering the display of such limits).

At operation 1010, responsive to receiving an instruction from an input device (e.g. the requesting computing device 108 displaying the UI 120) to modify at least one asset of the set of assets on the user interface screen indicative of generating a test portfolio, the following operations are then performed.

First at operation 1012, following operation 1010, the portfolio optimization tool 130 is configured to generate modifications to the asset allocation table displayed and predict, by the prediction engine 134, updated efficiency metrics for each of the assets in the test portfolio based on the historical asset allocation data which was previously received from the transaction processing system 102.

Second at operation 1014, following operation 1012, the portfolio optimization tool 130 is configured to update the user interface screen (e.g. UI 120) to generate a display of a test data asset allocation point based on the updated efficiency metrics for the test portfolio overlaid on the graph with the initial portfolio thereby visualizing a comparison of the test portfolio relative to the initial portfolio, the efficient frontier and the modified efficient frontier on a single graph (e.g. see FIG. 7).

In at least some aspects, the disclosed embodiments may generate and store information reflecting various correlation information (e.g. relationships between portfolio asset classes, asset features, and optimization factors including risk and returns) as retrieved from scenario building various iterations of the portfolio optimizer 104 via UI 120. For example, the portfolio optimizer 104, via the portfolio optimization tool 130, may generate and store such correlation information (e.g. characteristics of each scenario and resulting outcomes) in one or more data structures that are accessible and usable by one or more processors and software executed by processors to perform and improve one or more operations consistent with the disclosed embodiments.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit.

Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium. By way of example, and not limitation, such computer-readable storage media can comprise RAM, ROM, EEPROM, optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using wired or wireless technologies, such are included in the definition of medium. It should be understood, however, that computer-readable storage media and data storage media do not include connections, carrier waves, signals, or other transient media, but are instead directed to non-transient, tangible storage media.

Instructions may be executed by one or more processors, such as one or more general purpose microprocessors, application specific integrated circuits (ASICs), field programmable logic arrays (FPGAs), digital signal processors (DSPs), or other similar integrated or discrete logic circuitry. The term “processor,” as used herein may refer to any of the foregoing examples or any other suitable structure to implement the described techniques. In addition, in some aspects, the functionality described may be provided within dedicated software modules and/or hardware. Also, the techniques could be fully implemented in one or more circuits or logic elements. The techniques of this disclosure may be implemented in a wide variety of devices or apparatuses, an integrated circuit (IC) or a set of ICs (e.g., a chip set).

One or more currently preferred embodiments have been described by way of example. It will be apparent to persons skilled in the art that a number of variations and modifications can be made without departing from the scope of the disclosure as defined in the claims.

1. A system comprising a computer having at least one processor and a non-transient storage medium storing computer readable instructions, that when executed by said at least one processor of the computer, cause the computer to perform operations comprising:
providing a user interface screen for portfolio optimization, the user interface screen comprising:
a first curve displayed on a graph of expected returns and risk, the first curve indicating an efficient frontier of a model portfolio, the first curve derived from historical asset allocation data comprising features describing a set of historical assets, the historical asset allocation data provided as a first input from a transaction input device;
a data point overlaid on the graph indicating positioning of an initial portfolio relative to the efficient frontier, the initial portfolio retrieved based on a second input of asset allocation data describing a set of assets defined using the same features as the first input, the assets defined in an interactive asset allocation table for including proposed allocations for each of the assets and displaying efficiency metrics for each of the assets predicted, by a prediction engine, from the historical asset allocation data; and
a second curve displayed on the graph indicating a modified efficient frontier of feasible adjustments based on a third input of predetermined limits of upper and lower bounds of the features for at least one asset in the asset allocation table; and
responsive to receiving an instruction from an input device to modify at least one asset of the set of assets on the user interface screen indicative of generating a test portfolio:
generate modifications to the asset allocation table displayed and predict, by the prediction engine, updated efficiency metrics for each of the assets in the test portfolio based on the historical asset allocation data; and
update the user interface screen to generate a display of a test data point based on the updated efficiency metrics for the test portfolio overlaid on the graph with the initial portfolio thereby visualizing a comparison of the test portfolio relative to the initial portfolio, the efficient frontier and the modified efficient frontier on a single graph.

2. The system of claim 1, wherein the instructions further cause operations comprising:
determine, via communications of the instruction with a constraints engine whether the modifications satisfy predefined set of constraints defining permissive modifications to the set of assets;
responsive to determining that at least one modification does not satisfy the predefined set of constraints, automatically adjust the modification in the instruction to satisfy the permissive modifications; and
generate a notification on the user interface screen indicating adjusting the modification.

3. The system of claim 1, wherein the instruction to modify at least one asset comprises one of:
modifying asset class weight of one asset relative to other assets held in a particular portfolio; and
adding a new asset with associated asset class weight, the instruction causing the computer to predict, using the prediction engine, a new efficiency metric for the test portfolio including expected return and risk based on the historical asset allocation data.

4. The system of claim 1, wherein each asset in the asset allocation table is associated with an expected risk and an expected return defining a particular efficiency metric for an asset.

5. The system of claim 1, wherein receiving the instruction to modify at least one asset is received via an instruction to modify the asset on the asset allocation table or by selecting one or more data points on the graph of expected returns versus expected risk.

6. The system of claim 1, wherein at least some of the data points in the first curve and the second curve providing the efficient frontier and the modified efficient frontier displayed on the graph are selectable such that the selection causes the initial portfolio to modify the proposed allocations to said selection and update the efficiency metric.

7. The system of claim 1, wherein the user interface screen provided is configured to display a plurality of hypothetical asset allocation scenarios in both the asset allocation table and the graph to visualize a comparison to the efficient frontier and the modified efficient frontier.

8. The system of claim 1, further comprising a machine learning model on the computer, having been trained on the historical asset allocation data, and further configured to predict a target asset allocation weighting to modify the proposed allocation for each said asset in the asset allocation table and display the target asset allocation weighting to improve a fit between a data point representing the initial portfolio on the graph and a predetermined one of the first curve and the second curve displayed on the user interface screen.

9. The system of claim 1, wherein the instructions when executed by said at least one processor further cause operations of the computer comprising:
causing the user interface screen to display the asset allocation table configured to be editable to receive the third input from the input device, the asset allocation table displaying a table of features for each asset, the features comprising the upper bound and the lower bound of permissible increase or decrease in each asset with respect to other asset allocations.

10. The system of claim 1, wherein the instructions, when executed by the processor, further cause the computer to generate the user interface screen to visually differentiate on the first curve and the second curve, between various levels of expected risk and return such as to indicate one or more optimal points of each portfolio.

11. The system of claim 1, wherein in response to receiving an input from the input device for selecting points on the graph of the efficient frontier or the modified efficient frontier, the instructions, when executed by the processor, further cause the computer to update the asset allocation table and associated proposed allocations to reflect the selected points and associated values reflective of optimal expected return and risk.

12. A computer implemented method comprising:
providing, by a computer, a user interface screen for portfolio optimization, the user interface screen comprising:
a first curve displayed on a graph of expected returns and risk, the first curve indicating an efficient frontier of a model portfolio, the first curve derived from historical asset allocation data comprising features describing a set of historical assets, the historical asset allocation data provided as a first input from a transaction input device;
a data point overlaid on the graph indicating positioning of an initial portfolio relative to the efficient frontier, the initial portfolio retrieved based on a second input of asset allocation data describing a set of assets defined using the same features as the first input, the assets defined in an interactive asset allocation table for including proposed allocations for each of the assets and efficiency metrics for each of the assets predicted, by a prediction engine, from the historical asset allocation data; and
a second curve displayed on the graph indicating a modified efficient frontier of feasible adjustments based on a third input of predetermined limits of upper and lower bounds of the features for at least one asset in the asset allocation table; and
responsive to receiving an instruction, by the computer and from an input device, to modify at least one asset of the set of assets on the user interface screen indicative of generating a test portfolio:
generate, by the computer, modifications to the asset allocation table displayed and predict, by the prediction engine, updated efficiency metrics for each of the assets in the test portfolio based on the historical asset allocation data; and
update, by the computer, the user interface screen to generate a display of a test data point based on the updated efficiency metrics for the test portfolio overlaid on the graph with the initial portfolio thereby visualizing a comparison of the test portfolio relative to the initial portfolio, the efficient frontier and the modified efficient frontier on a single graph.

13. The method of claim 12, further comprising:
determine, via communications of the instruction with a constraints engine whether the modifications satisfy predefined set of constraints defining permissive modifications to the set of assets;
responsive to determining that at least one modification does not satisfy the predefined set of constraints, automatically adjust the modification in the instruction to satisfy the permissive modifications; and,
generate a notification on the user interface screen indicating adjusting the modification.

14. The method of claim 12, wherein the instruction to modify at least one asset further comprises one of:
modifying asset class weight of one asset relative to other assets held in a particular portfolio; and
adding a new asset with associated asset class weight, the instruction causing the computer to predict, using the prediction engine, a new efficiency metric for the test portfolio including expected return and risk based on the historical asset allocation data.

15. The method of claim 12, wherein each asset in the asset allocation table is associated with an expected risk and an expected return defining a particular efficiency metric for an asset.

16. The method of claim 12, wherein receiving the instruction to modify at least one asset is received via an instruction to modify the asset on the asset allocation table or by selecting one or more data points on the graph of expected returns versus expected risk.

17. The method of claim 12, wherein at least some of the data points in the first curve and the second curve providing the efficient frontier and the modified efficient frontier displayed on the graph are selectable such that the selection causes the initial portfolio to modify the proposed allocations to said selection and update the efficiency metric.

18. The method of claim 12, wherein the user interface screen provided is configured to display a plurality of hypothetical asset allocation scenarios in both the asset allocation table and the graph to visualize a comparison to the efficient frontier and the modified efficient frontier.

19. The method of claim 12, further comprising, providing a machine learning model on the computer, having been trained on the historical asset allocation data, and further configured to predict a target asset allocation weighting to modify the proposed allocation for each said asset in the asset allocation table and display the target asset allocation weighting to improve a fit between a data point representing the initial portfolio on the graph and a predetermined one of the first curve and the second curve displayed on the user interface screen.

20. The method of claim 12, further comprising:
causing the user interface screen to display the asset allocation table configured to be editable to receive the third input from the input device, the asset allocation table displaying a table of features for each asset, the features comprising the upper bound and the lower bound of permissible increase or decrease in each asset with respect to other asset allocations.

21. The method of claim 12, further comprising:
generating, by the computer, the user interface screen to visually differentiate on the first curve and the second curve, between various levels of expected risk and return such as to indicate one or more optimal points of each portfolio.

22. The method of claim 12, wherein in response to receiving an input from the input device for selecting points on the graph of the efficient frontier or the modified efficient frontier, the method comprising updating the asset allocation table and associated proposed allocations to reflect the selected points and associated values reflective of optimal expected return and risk.

23. A computer implemented method comprising:
accessing, by a computing device, and from a first transaction device, a first input of historical asset allocation data comprising features describing each of the assets and historical efficiency metrics;
receiving, by the computing device, and from an input device on a user interface, a second input of proposed asset allocation data defined using the features as the first input;
receiving, by the computing device, and from the input device, a third input of predetermined restrictions on asset allocations provided on the user interface, the restrictions comprising upper and lower bound ranges for at least one asset; and
applying the first, second, and third input by the computing device, to a machine learning model to:
generate and present a constraint efficient frontier curve on a screen of the user interface using the restrictions and the historical allocation data having the historical efficiency metrics;
predict, based on the constraint efficient frontier curve, a set of hypothetical modification changes to allocation weighting from the proposed asset allocation data based on relative risk reward ratio retrieved from the constraint efficient frontier curve and within the predetermined restrictions to lessen a difference between the proposed asset allocation data and the constraint efficient frontier curve; and
present the prediction indicative of the modification changes and the constraint efficient frontier curve on the screen of the user interface for interaction therewith.
